(19) United States
(12) Patent Application Publication
(10) Pub. No.: US 2013/0217407 A1
(43) Pub. Date: Aug. 22, 2013

(54) METHOD FOR DECIDING ON A POTENTIAL LOAD BALANCING OPERATION IN A WIRELESS NETWORK AND NETWORK ELEMENT FOR A WIRELESS NETWORK

(71) Applicants: Christian Gerlach, Ditzingen (DE); Oliver Stanze, Stuttgart (DE); Bozo Cesar, Stuttgart (DE)

(72) Inventors: Christian Gerlach, Ditzingen (DE); Oliver Stanze, Stuttgart (DE); Bozo Cesar, Stuttgart (DE)

(73) Assignee: ALCATEL LUCENT, Paris (FR)

(21) Appl. No.: 13/880,617

(22) PCT Filed: Oct. 14, 2011
(86) PCT No.: PCT/EP11/67988

§ 371 Date: Apr. 19, 2013

(30) Foreign Application Priority Data
Nov. 5, 2010 (EP) 10290594.0

(51) Int. Cl. H04W 28/08

(52) U.S. Cl. CPC H04W 28/08
USPC 455/453

(57) ABSTRACT

The present invention refers to a method (41) for a deciding on whether to perform a potential load balancing operation (57) in a wireless network (11) having a first cell with second cells embedded therein. In order to improve the overall performance of the network (11) a method (41) for deciding on a potential load balancing operation (57) in a wireless network (11) comprising a first base station (15) having a first cell (13) and at least one second base (21) station having a second cell, the first cell (13) and the second cell (21) at least partially over lapping each other, is suggested. This method (41) comprises evaluating (45) an impact of the potential load balancing operation (57) to an overall performance metric (M), said metric (M) characterizing the performance of the first cell (13) and the at least one second cell (19), and initiating the load balancing operation (57) if said evaluating indicates that the potential load balancing operation (57) would improve the performance according to the performance metric (M).

### FIELD OF THE INVENTION

The present invention refers to a method for deciding on a potential load balancing operation in a wireless network comprising a first base station having a first cell and at least one second base station having a second cell, the first cell and the second cell at least partially overlapping each other. Furthermore, the present invention refers to a network element of a wireless network, such as a macro base station or a pico base station, being arranged for executing such a method.

### BACKGROUND

Hierarchical cellular networks are known in the art. Hierarchical networks typically have comparatively large macro cells. So-called pico cells which are smaller than the macro cells are embedded at least partially within a macro cell. A mobile terminal that is registered with a macro cell and located within a coverage area of a pico cell embedded within the macro cell may perform a handover from the macro cell to the pico cell, switching data traffic originally transferred between the macro base station and the terminal to the pico base station.

In many cases, the pico cell improves the overall performance of the cellular network because the macro base station may hand over at least some terminals located within the pico cell to the pico base station so that these terminals perceive a better quality of service and the macro base station has more radio resources available to serve the terminals that remain registered with a macro base station.

In particular, if the macro base station and the pico base station use the same radio resources, the size of the pico cell depends on the transmit power used by the macro base station and the one used by the pico base station for transmitting on these radio resources or a portion thereof. For instance, if the transmit power of the pico base station can not be increased or if the macro transmit power is comparatively high then interference between the macro base station and the pico base station results in a comparatively low size of the pico cell. A low transmit power results in a comparatively large pica cell because the interference is comparatively low.

### SUMMARY

The object of the present invention is to provide a method for deciding on a potential load balancing operation, that allows for coordinating the operation of the macro base station and at least one pico base station such that an overall performance of the macro cell and the pico cell embedded in that macro cell is improved.

According to an embodiment of the present invention, a method for deciding on whether to perform a load balancing operation in a wireless network comprising a first base station having a first cell and at least one second base station having a second cell, the first cell and the second cell at least partially overlapping each other, is provided. This method comprises evaluating an impact of a potential load balancing operation to an overall performance metric, said metric characterizing the performance of the first cell and the at least one second cell, and performing the load balancing operation if said evaluating indicates that the potential load balancing operation would improve the performance according to the performance metric. The performance metric may characterize or depend on an overall throughput of the first cell and the second cell and/or a fairness of resource assignment to terminals registered with the first base station or the second base station. However, in certain embodiments, the performance metric may depend on different characteristics of the wireless network.

By evaluating the load balancing operation by means of the performance metric before performing the load balancing operation the method prognosticates whether the load balancing operation most probably would improve the performance according to the performance metric or not. Thus, inappropriate load balancing operations can be avoided and the overall performance in terms of throughput, fairness or the like is improved.

Preferably, the network is a hierarchical cellular network, the first cell being a macro cell and the second cell being a pico cell, a coverage area of the pico cell being smaller than a coverage area of the macro cell, and wherein the first base station is a macro base station controlling the macro cell and the second base station is a pico base station controlling the pico cell. The macro cell and the pico cell overlap each other at least partially, i.e., the pico cell may be located completely within the macro cell or the pico cell may be located at a cell border of the macro cell so that only a part of the pico cell is located within the macro cell.

In a preferred embodiment, said evaluating comprises calculating a current value of the performance metric related to a current operating station of the first cell and the at least one second cell and calculating a predicted value of the performance metric related to an operating state of the first cell and the at least one second cell that would appear if the load balancing operation would be performed. The current value and the predicted value may be compared with each other. The method may decide depending on this comparison on whether to perform the load balancing operation.

In another preferred embodiment, the values of performance metric are determined based on a radio resource management model and the metric is preferably a minimum terminal bit rate.

The overall performance metric characterizes the performance of the first cell including the at least one second cell that at least partially overlaps that first cell and therefore relates to multiple cells and the corresponding base stations. In an embodiment, the method comprises determining at least one cell specific value of a cell specific performance metric, said cell specific value characterizing the performance of the first cell or the second cell and determining the current value and/or the predicted value depending on the at least one cell specific value.

Deciding on the load balancing operation is related to the first base station and the at least one second base station. Therefore, it is desirable to coordinate decisions on whether to perform the load balancing operation among the first base station and the concerned second base stations. In a preferred embodiment this coordinating is carried out by exchanging with network elements, preferably with the first base station and/or the second base station, the cell specific values, the values of the overall performance metric, and/or an indication for indicating whether said evaluating indicates that the potential load balancing operation would improve the performance according to the performance metric.

In an embodiment, performing the load balancing operation comprises triggering a handover of a terminal from the first cell to the second cell or from the second cell to the first cell. According to this embodiment, a potential handover is evaluated using the performance metric. If this evaluation shows that a handover would improve the combined performance of the first cell and the at least one second cell then the handover is performed. Otherwise, the handover is postponed or completely cancelled.

Preferably, the method comprises transmitting to a handover target base station at least one parameter characterizing radio conditions related to the terminal, preferably a pathloss between the terminal and at least one base station.

In an embodiment, performing the load balancing operation comprises limiting a transmit power of a signal transmitted by the first base station over a portion of radio resources of the first cell and the second cell. Limiting the transmit power typically augments the size of the second cell so that more terminals residing within the first cell may register with the second cell. However, increasing the size of the second cell does not always improve the overall performance. For example, if there is already a large number of terminals registered with the second cell and if there is a comparatively high load in the second cell then increasing the size of the second cell making even more terminals register with that second cell will not improve the overall performance because a large number of terminals share the second cell whereas the first cell is used only little. However, if the second cell is almost empty then increasing the size of the second cell improves the overall performance because the second cell can reach more terminals that may leave the first cell and register with the second cell. When limiting the transmit power depending on the evaluating of the performance metric allows for semi-statically increase of the size of the second cell if appropriate.

Preferably, the portion of the radio resources corresponds to a time interval, preferably a frame or a subframe of a framing structure of the wireless network, or a portion of the frame or the subframe. In particular, the first base station may limit the transmit power, preferably completely suppress signal transmissions, within at least one portion of the frame or the subframe. In this case in a time synchronized system, the first base station transmits only in that part of the frame or the subframe that is used for transmission of reference symbols (e.g. pilots) for mobility measurements, whereas the remaining parts of the frame or the subframe are not used by the first base station at all. This way the suppression by the first base station also eliminates interference on the portion of the subframe that is used for the control channel. When applying the method in the Long Term Evolution (LTE) system, the first base station may suppress transmission in all portions of a subframe except these portions of the subframe that are used for transmitting reference symbols (pilots). These subframes are also referred to almost blank subframes (ABS).

In an embodiment, the method comprises reverting said limiting the transmit power. For example, if a large size of the second cell is not required anymore then the first base station may stop limiting the transmit power and use the corresponding portion of the radio resources for communicating with a terminal registered with the first base station.

Preferably, the method comprises evaluating an impact of reverting limiting the transmit power to the overall performance metric and reverting said limiting if said evaluating indicates that said reverting would improve the performance according to the performance metric.

In order to evaluate the impact of the performance metric, the method may comprise calculating the current value of the performance metric relating to the current operating state, calculating the predicted value of the performance metric relating to an operating state that most probably will appear if limiting the transmit power is reverted. For deciding on reverting limiting the transmit power the current value of the performance metric may be compared with the predicted value of the performance metric.

Preferably, the method may comprise determining at least one cell specific value of a cell specific performance metric, said cell specific value characterizing the performance of the first cell or the second cell, and wherein the predicted value of one cell is derived in approximation from a load information submitted in relation to predefined thresholds.

In an embodiment of the present invention, the method comprises transmitting a handover request message from the first base station to the second base station and signalling to the second base station a portion of the radio resources on which the first base station is willing to limit the transmit power if the second base station accepts a handover specified by the handover request. This allows for combining the two above described load balancing operations, i.e. triggering a handover and limiting the transmit power.

In an embodiment, the method comprises transmitting a limiting request from the second base station to the first base station for requesting the first base station to limit the transmit power of the signal transmitted over a portion of radio resources. Preferably, the method comprises transmitting a handover request from the first base station to the second base station and receiving a handover rejection from the second base station, the handover rejection indicating whether the second base station cannot accept the requested handover due to insufficient control channel radio condition to the terminal. In an embodiment, the method comprises transmitting a handover request from the first base station to the second base station and limiting the transmit power of the signal transmitted by the first base station over a portion of the radio resources if a handover rejection related to said handover request is received from the second base station. So in one embodiment the method comprises that a handover rejection indicates that the second base station cannot accept the requested handover due to insufficient control channel condition to the terminal. After having received the handover rejection and after having limited the transmit power, the first base station may transmit a further handover request to the second base station. Under normal circumstance, limiting the transmit power should have removed the insufficient control channel condition to the terminal and the second base station should be able to accept the requested handover.

In an embodiment, the method comprises transmitting a limiting request from the second base station to the first base station for requesting the first base station to limit the transmit power of the signal transmitted over a portion of the radio resources. In particular when applying the method in a LTE system, the limiting request may be a muting request for requesting the first base station to insert almost blank subframes (ABS) into the framing structure of LTE.

In an embodiment said evaluating is performed on a single network element, preferably on a base station. For instance, the performance metric may be calculated by the first base station only, with the second base station transmitting values specific to the second cell to the first base station. In particular, the second base station may calculate only the current value of the metric specific to the second cell and transmit this value to the first base station.

According to an embodiment, a network element of a wireless network is provided, said network comprising a first base station having a first cell and at least one second base station having a second cell, the first cell and the second cell at least partially overlapping each other, wherein the network element comprises control means arranged for evaluating an impact of a potential load balancing operation to an overall performance metric, said metric characterizing the performance of the first cell and the at least one second cell, and performing the load balancing operation if said evaluating indicates that the potential load balancing operation would improve the performance according to the performance metric. The control means may comprise, e.g., a processor or micro computer programmed for executing a method according the present invention, embodiments of which are described above.

Preferably, the network element is the first base station or the at least one second base station, the control means of which being arranged for executing a method a method according to the present invention, embodiments of which are described above.

### BRIEF DESCRIPTION OF THE FIGURES

Preferred embodiments and further advantages of the present invention are shown in the figures and described in detail hereinafter.

FIG. 1 shows a cellular communication network;

FIG. 2 shows network elements of the cellular network shown in FIG. 1;

FIG. 3 shows diagrams of resource allocation in the network shown in FIG. 1;

FIG. 4 shows a flow chart of a method for operating a network element of the network shown in FIG. 1; and

FIG. 5 shows a sequence chart of signalling messages exchanged between a pica base station and a macro base station of the cellular network shown in FIG. 1.

### DESCRIPTION OF THE EMBODIMENTS

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

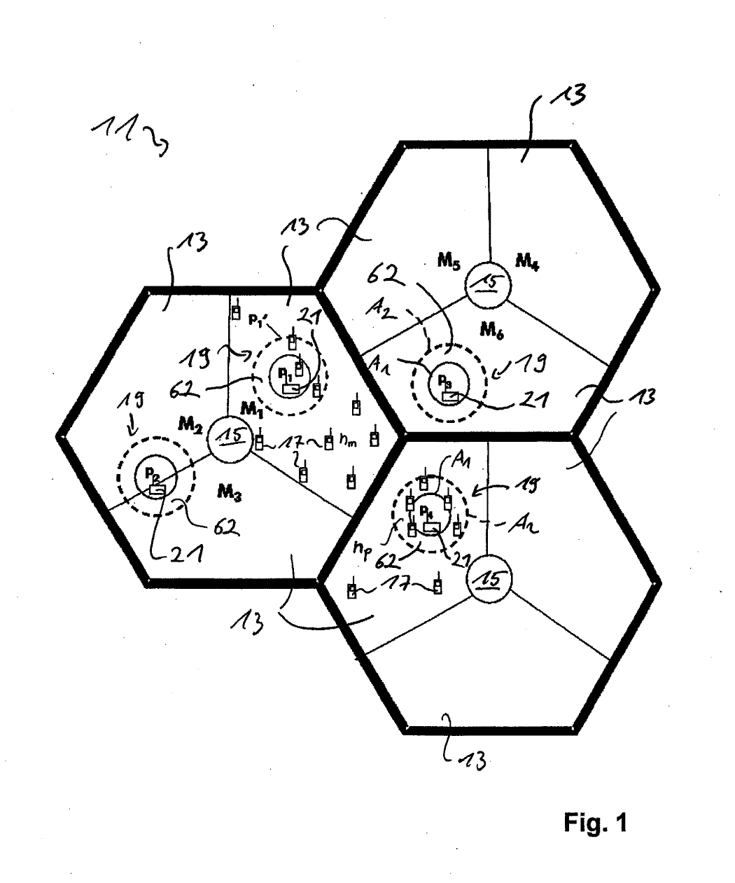

FIG. 1 shows a cellular network 11 having multiple macro cells 13. Each macro cell 13 has a macro base station 15 arranged for controlling the macro cell 13, in particular terminals 17 located within that macro cell 13 and registered with the macro base station 15 of that macro cell 13. In the shown embodiment a single macro base station 15 is assigned to three macro cells 13. In another embodiment, only one macro cell 13 is assigned to a macro base station 15.

Furthermore, the cellular network 11 has multiple pico cells 19, each of them having a pico base station 21. In the shown exemplary embodiment, each pico base station 21 controls exactly one pico cell 19 and terminals 17 registered with the corresponding pico base station 21. A maximum transmission power of a radio signal transmitted by a pico base station 21 is less than a maximum transmission power of a radio signal sent by the macro base station 15. Consequently, the size of a pico cell 19, i.e., the coverage area of a pico cell, is less than the size of a macro cell 13. The pico cells 19 are overlapping with at least one macro cell 13. A pico base station 21 is preferably located within an area where a density of terminals 17 is comparatively high. At least a part of the terminals 17 located within a pico cell 19 may leave the macro cell 13 and register with the pico base station 21 of the pico cell 19. In this way, installing pico base stations 21 in areas with a high density of terminals 17 helps to improve a quality of service and/or a channel capacity experienced by users of the terminal 17 located in that area having a high terminal density.

The cellular network 11 may be part of a Long Term Evolution (LTE) or Long Term Evolution advanced (LTE advanced) mobile communication system. Both LTE and LTE advanced are specified by the Third Generation Partnership project (3GPP). However, the present invention is not limited to LTE or LTE advanced. In LTE the base stations 13, 15 are referred to as enhanced nodeB (eNodeB). The terminals 17 are often referred to as User Equipment (UE). The invention may be applied in connection with different types of cellular networks or mobile communication systems, too.

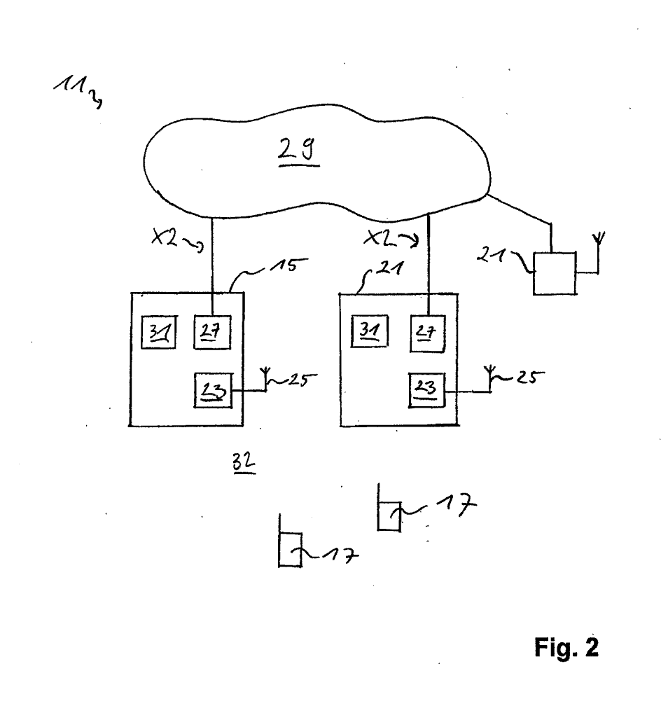

FIG. 2 shows network elements of the network 11, such as the macro base station 15 and the pico base station 21 in more detail. Each base station 15, 21 has a transceiver 23 coupled with an antenna 25 for transmitting a radio signal to terminals 17 and for receiving a radio signal sent by the terminals 17.

The base stations 15, 21 have interconnection network interface circuitry 27 connected to interconnection means for interconnecting the base stations 15, 21 to each other, such as an interconnection network 29. When using LTE, the base stations 15, 21 may communicate with each other according to the so-called X2 interface.

Moreover, the base stations 15, 21 comprise control means 31 such as control circuitry preferably comprising a processor programmed for executing a method for operating the base station 15, 21. In particular, the control means 31 may be configured, preferably programmed, for executing a method for deciding on a potential load balancing operation in the wireless network 11. An exemplary method for deciding on the potential load balancing operation is described below.

When operating the network 11 having at least one pico cell 19 located at least partially inside a coverage of the macro cell 13 the overall throughputs of all cells 13, 19 and or the quality of service seen by the terminals 17 shall be maximized. To this end, the network 11 may perform a load balancing operation in order to move load from the macro cell 13 to a pico cell 19 and vice versa.

If the macro cell 13 and a pico cell 19 use the same radio resources, in particular if the same radio carrier is used then time domain inter-cell interference coordination (ICIC) may be used in order to coordinate interference on the control channel. If the cells 13, 19 use both multiple carriers then frequency-domain ICIC may be used in order to coordinate interference on the control channel.

Because the pico base stations 21 have a comparatively small form factor and because of regulatory restrictions the power of a signal emitted by the pico base station 21 is a low compared to the power of a signal emitted by the macro base station 15. Therefore, a coverage area A₁ of a pico cell 19 is smaller than the coverage area of a macro cell 13. In case that only a small number of terminals 17 is registered with a pico cell 19 then a possible load balancing operation may consist in decreasing a maximum transmit power used by the macro base station 15 for transmitting a portion of radio transmission resources 32 in order to increase the coverage area of the pico cell 19. Decreasing of the transmit power used by the macro base station 15 in that portion of the radio resources 32 reduces interference between the macro base station 15 and the terminals 17 of the pico base station 21 so that the pica base station 21 may reach terminals 17 that are located rather distant from the pica base station 21. Thus reducing or limiting the maximum transmit power on the portion of the radio resources 32 by the macro base station leads to an increased coverage area A₂ (see FIG. 1) of the pica cell 19. The increase of the coverage area of the pico cell 19 due to reducing the interference by the macro base station is also referred to as “foot print increase”.

Theoretically, it is also possible to augment the coverage area of the pico cell 19 by increasing the transmit power used by the pico base station 21. However, in many cases, the transmit power of the pico base station 21 is limited by the small form factor of the pico base station 21 or by regulatory restrictions.

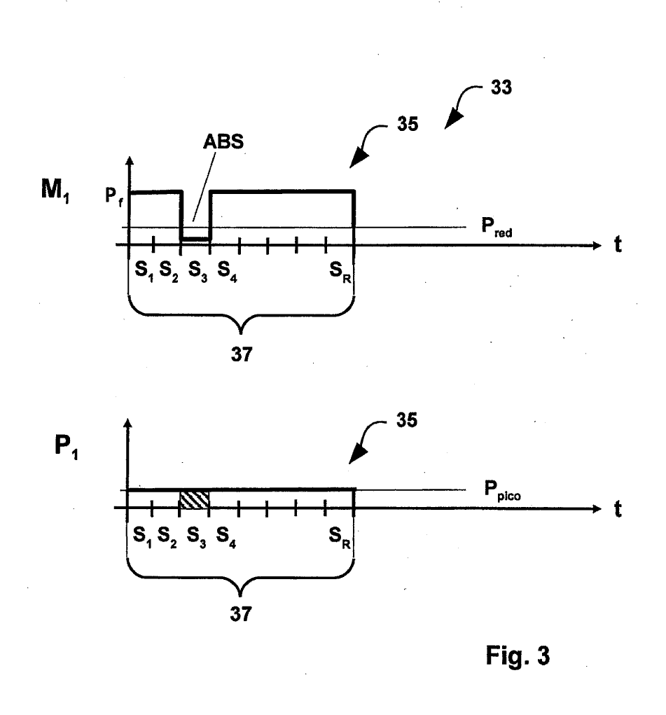

FIG. 3 shows a transmit power P of signals emitted by the macro base station 15 of a macro cell M₁ and a pico base station 21 of a pico cell P₁ over a common time axis. The radio transmission resources 32 comprise a carrier 33 that is used in both cells M₁ and P₁. The network 11 maintains a framing structure 35. The framing structure 35 comprises subsequent radio frames 37. In FIG. 3, only one radio frame 37 is shown. Each radio frame 37 is subdivided into multiple subframes S₁, . . . S_{R}, with R indicating the total number of subframes within a single radio frame 37. As can been seen in FIG. 3, the base stations 15, 21 of cells M₁ and P₁ are synchronized with respect to each other concerning the framing structure 35, in particular the timing of the radio frames 37 and the subframes S₁, . . . S_{R}.

As shown in the diagram in the top of FIG. 3, a subframe S₃ with a limited transmission power is inserted into the sequence of subframes S₁, . . . S_{R} of the macro base station 15. When using LTE, the macro base station 15 transmits during this subframe S₃ only essential reference symbols. Therefore, only the parts of the subframe S₃ allocated for the corresponding reference symbols are used by the macro base station 15, whereas the macro base station 15 does not transmit at all during the remaining parts of that subframe S₃. Therefore, the subframe S₃ is also referred to as Almost Blank Subframe (ABS).

In another embodiment, the transmit power P of the signal emitted by the macro base station 15 of cell M₁ is limited to a reduced power level P_{red} for subframe S₃. In another embodiment the macro base station 15 of cell M₁ does not transmit at all during the whole subframe S₃.

Because the transmit power of the signal emitted by the macro base station 21 of cell M₁ is considerably reduced interference with a signal emitted by the pico base station 21 of cell P₁ is reduced during subframe S₃. Therefore, the pico base station 21 of cell P₁ can reach terminals 17 that are relatively distant from that pico base station 21. In other words, the coverage area of the pico cell P₁ increases.

Terminal 17 located in the increased coverage area A₂ can receive control channel signals emitted by the pico base station 21 (e.g. the Physical Downlink Control Channel, PDCCH of LTE) without experience interference from the macro base station 15 of cell P₁ in subframe S₃. Furthermore, a data channel (e.g. the Physical Downlink Shared Channel, PDSCH of LTE) of the pica cell P₁ in subframe S₃ does not experience interference from the macro base station 15 of the cell P₁ if a terminal 17 registered with the pico base station 21 resides within the increased coverage area A₂. Preferably, the subframe S₃ during which a transmit power of the macro base station 15 is reduced is signalled to the terminal 17 in order to avoid problems of channel estimation, channel state measurements and radio/or link failure detection that may occur when inserting ABS into the radio frame 37.

Thus terminals 17 that reside within the increased coverage area A₂ but not within the regularly coverage area A₁ are preferably scheduled in the subframes that are power restricted by the macro base station 15 because they can then receive the control channel (PDCCH) from the pico base station 21.

In the shown embodiment, the pico base station 21 does not change the transmit power of the signals emitted into the pico cell P₁. The transmit power is always P_{pico} for all subframes S₁, . . . S_{R}.

In the shown embodiment only one subframe S₃ with reduced transmit power is inserted into the radio frame 37. However, multiple subframes with limited transmit power, e.g. ABS, may be inserted into a single radio frame 37.

If the coverage area of the pico cell P₁ increases then more terminals 17 may register with the cell P₁. As a consequence, load of the macro cell M₁ is moved to the pico cell P₁. In this sense, limiting the transmit power during a subframe S₁, . . . S_{R} (e.g. inserting an ABS into the radio frame 35) is a load balancing operation.

However, increasing the coverage area of a pico cell 19 does not always improve the performance of the network 11. For example, if there are already many terminals 17 using a single pico cell 19 then adding additional terminals 17 to this pico cell 19 does not improve the overall performance because the pico cell 19 is already heavily loaded. In such a situation some terminals located in the coverage area of the pico cell 19 should remain in the macro cell 13. Thus, inserting the subframe S₃ with the limited transmit power is not needed. Moreover, avoiding inserting a subframe S₃ with the limited transmit power or removing a previously inserted subframe with limited transmit power increases the performance of the network 11 because the macro base station 15 has more radio transmission resources 32 available for communicating with terminals 17 that are not registered with the pico base station 19. Therefore, in an embodiment of the present invention, the decision on whether to insert a subframe S₃ with limited transmit power is taken semi-statically depending on an operating state of the network 11.

A second type of load balancing operation consists in triggering a handover of a communication session of a terminal 17 from one base station 15, 21 to another base station 21, 15. Handovers between the macro base station 15 and the pica base station 21 immediately transfers network load caused by this terminal 17 between the base stations 15, 21.

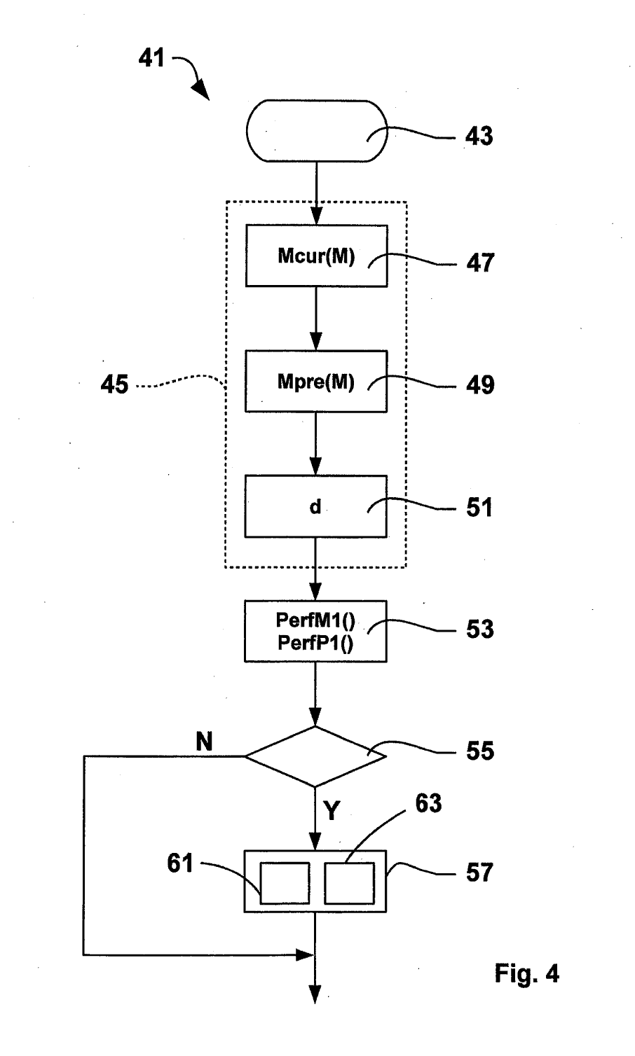

FIG. 4 shows a method for semi-statically deciding on whether to perform a load balancing operation, e.g. inserting a subframe with limited transmit power or triggering a handover between the macro cell 13 and the pica cell 19, depending on a current operating state of the network 11, in particular of the macro cell 13 and all pica cells 19 that are located at least partially within that macro cell 13. After a start 43 of the method 41, an impact of a potential load balancing operation on an overall performance metric M characterizing the performance of the macro cell 13 and all pica cells 19 located at least partially within that macro cell 13 is evaluated in block 45.

Block 45 comprises a step 47 of calculating a current value M_{cur} of the performance metric M related to the current operating state of the macro cell 13 and the pico cells 19. Furthermore, the block 45 comprises a step 49 of calculating a predicted value Mₚᵣₑ of the performance metric M related to an hypothetical operating state that will appear if the load balancing operation is performed. After steps 47 and 49 a step 51 is executed that compares the current value M_{cur} and the predicted value Mₚᵣₑ of the performance metric M and determines whether the load balancing operation would improve the performance characterized by the performance metric M. Step 51 takes a decision d on whether the load balancing operation should be performed.

The method 41 may be executed in a distributed manner. For example, multiple network elements of the network 11, such as the macro base station 15 and the pico base station 21 may execute at least some of the steps shown in FIG. 4. In order to coordinate the decision on whether the load balancing operation should be performed between these network elements 15, 21, the method 41 may comprise a step 53 that exchanges the values M_{cur}, Mₚᵣₑ of the performance metric M and/or the decision d taken based on these values M_{cur}, Mₚᵣₑ with other network elements 15, 21. Then a branch 55 is executed for definitely decide on whether to perform the load balancing operation. Step 55 may decide depending on the decision d and/or a result of the information exchange 53. If step 55 decides that the load balancing operation shall be performed (Y) then the step 57 of the method 41 is executed that triggers or performs the load balancing operation. Otherwise (N) step 57 is skipped and the method 41 is terminated. After step 55 has been executed the method 41 is terminated.

In an embodiment, branch 55 decides to perform the load balancing operation if the decision d indicates that the load balancing operation shall be performed and step 53 shows that the other network elements 15, 21 have taken the same decision d. In another embodiment the network elements 15, 21 carry out the same method on the same input parameters independently and come to the same decision. In further different embodiments the network elements 15, 21 may negotiate whether the load balancing operation shall be performed in a different way. In yet another embodiment, step 53 is omitted and branch 55 decides depending on the decision d only.

The method 41 may be executed repeatedly or periodically. In an embodiment, the method 41 is executed each time a potential load balancing operation has been determined and a decision on whether to perform this load balancing operation is required.

In a preferred embodiment, the metric M comprises the result of a radio resource management model (RRM model). These performance metrics include at least one of: cell throughput, a minimum throughput of the terminals 17 (e.g. a certain percentile related to the throughput, for instance the fifth percentile), a minimum terminal bit rate in a cell 13, 19, an average or maximum packet delay, or a fairness metric characterizing an overall fairness of radio resource allocation to the individual terminals 17.

The RRM model may use one or more of the following input parameters: number of terminals 17 registered with a cell 13, 19, traffic characteristics (e.g. required bit rates) of the terminals 17, interference experience by the terminals 17, channels of the serving cell 13, 19, path losses between a base station 15, 21 and a terminal 17. In an embodiment, the fact whether a terminal 17 can be reached by a certain base station 15, 21, in particular whether a control channel of that base station 15, 21 can be received by the terminal 17, forms an input parameter of the RRM model.

The RRM model may use a part of the above parameters only. For example, a quite simple RRM model may be provided that models an average terminal throughput.

The load balancing operation 57 may comprise a handover 61 between the macro cell 13 and a pico cell 19. As shown in the equations below the performance metric is evaluated before a handover has taken place (symbol “noHO”) and evaluated assuming a handover would take place (symbol “HO”).

$$\begin{matrix}PerfP 1 ( noHO ) = RRMpico ( noHO ) \\ PerfM 1 ( noHO ) = RRMmacro ( noHO )\end{matrix} \} {M}_{cur} \\ \begin{matrix}PerfP 1 ( HO ) = RRMpico ( HO ) \\ PerfM 1 ( HO ) = RRMmacro ( HO )\end{matrix} \} {M}_{pre}$$

The situation before the handover is a combined resulting in an the performance indicator M_{cur} and the operating state predicted after the handover is combined resulting in a predicted indicator Mₚᵣₑ. The handover decision is taken when an overall improvement of the combined performance is achieved, i.e. the handover is performed if Mₚᵣₑ>M_{cur}.

As shown in the above equations, the values M_{cur} and Mₚᵣₑ of the overall performance metric M may be calculated depending on values PerfP1( ), PerfM1( ) of cell specific performance metrics. These values may be calculated by using a cell specific radio resource model RRMpico( ), RRMmacro( ). In a preferred embodiment, the base stations 15, 21 exchange the cell specific values PerfP1( ), PerfM1( ) and/or the overall values M_{cur}, Mₚᵣₑ. Step 53 may comprise exchanging the values PerfP1( ), PerfM1( ) of the cell specific performance metrics as current and predicted values and/or exchanging values M_{cur} and Mₚᵣₑ of the overall performance metric M between the base stations 15, 21. In an embodiment, the macro base station 15 calculates the values PerfM1( ) of the cell specific performance metric related to the macro cell M1 and/or the pico base station 21 calculates the values PerfM1( ) of the cell specific performance metric related to the pico cell P1. In this case, the macro base station 15 does not need to calculate the values PerfP1 and the pico base station 21 does not need to calculate the values PerfM1.

In an embodiment, the above described predicted evaluation of the operating state after the handover may facilitated by sending information about the designated terminal 17 (e.g. its path loss to the serving cell and or interference cell) to a target base station 15, 21.

The load balancing operation may also comprise limiting (step 63) the transmit power of a signal send by the macro base station 15 on a portion of the radio transmission resources 32. This portion of the transmission resources 32 may correspond to a time interval such as a subframe S₁, . . . S_{R}. In particular at least one ABS may be inserted into the framing structure 35 as described above.

In one embodiment, the macro base station 15 offers with a handover request message sent to a pico base station 21 to add one or more ABS. The pica base station 21 takes into account this offered ABS in evaluating the performance metrics. Due to an improved performance, in particular control channel performance, in the pico cell 19 due to the offered ABS it is more likely that the handover will be performed.

In another embodiment, the macro base station 21 does not offer with the handover request message to insert an ABS into the framing structure 45. This could lead to the performance—as indicated by the estimated value of the performance metric—decreasing after the potential handover has been performed such that the handover will not take place. However, the pico base station 21 may send a handover rejection message to the macro base station 15, this message including an indication that the handover rejection is due to insufficient control channel condition to the location of the terminal 17. After having received this handover rejection message the macro base station 21 may change the ABS configuration, in particular the macro base station 15 may add an ABS in the framing structure 45 and send a new handover request message to the pico base station 21.

In both above described embodiments as result, a handover from the macro base station 15 to the pico base station 21 is combined with limiting the transmit power of the signal send by the macro base station 15 on a portion of the radio transmission resources 42.

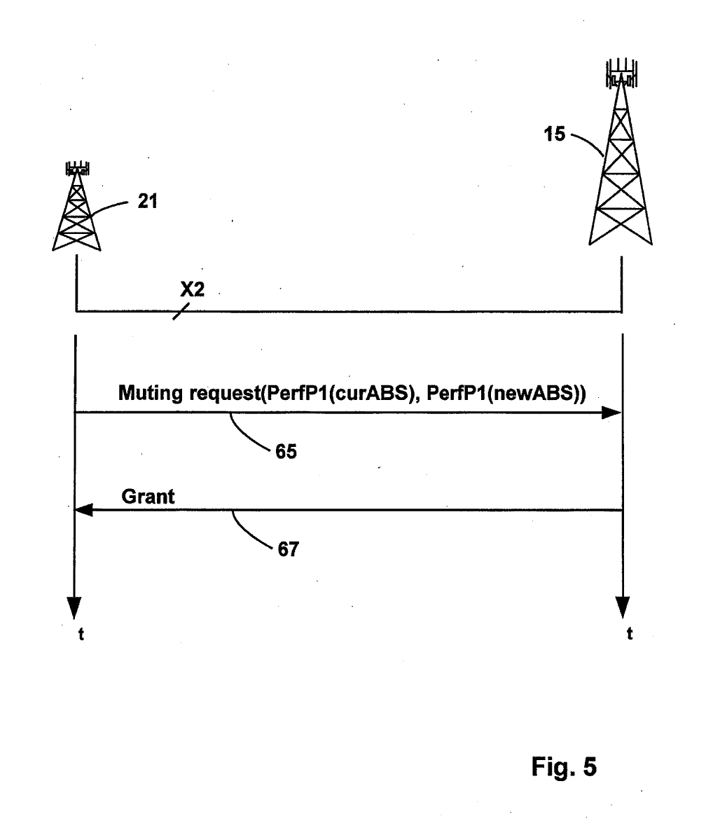

In an embodiment, the pico base station 21 may send a qualified muting request 65 to the macro base station 15 as shown in FIG. 5. By sending the muting request 65, the pico base station 21 requests adding an ABS in the framing structure 35 of the macro cell 13. The muting request 65 may comprise the current value PerfP1(curABS) being part of the performance metric M_{cur} or the current value M_{cur} of the overall metric M and the predicted value PerfP1(newABS) being part of the performance metric Mₚᵣₑ or this metric Mₚᵣₑ itself. The predicted value PerfP1(curABS) characterizes an estimated performance the pico base station 21 would have if the ABS is inserted. The macro base station 15 receives the muting request 65 or maybe multiple muting requests and evaluates its own performance without the additional ABS and the predicted performance when the ABS is added. By combining the multiple performance metrics into two overall performance metrics M_{cur} and Mₚᵣₑ and comparing them the decision to add an ABS is taken. To take this decision, the method 41 may be executed. When the overall performance of multiple cells (one or more pico cells 19 and one macro cell 13) is estimated to be improved then the additional ABS is set, otherwise it is not.

The following equations show how the values M_{cur} and Mₚᵣₑ of the overall performance metric M are calculated:

$$\begin{matrix}PerfP 1 ( curABS ) = RRMpico ( curABS ) \\ PerfM 1 ( curABS ) = RRMmacro ( curABS )\end{matrix} \} {M}_{cur} \\ \begin{matrix}PerfP 1 ( newABS ) = RRMpico ( newABS ) \\ PerfM 1 ( newABS ) = RRMmacro ( newABS )\end{matrix} \} {M}_{pre}$$

The operating state curABS before the additional ABS is inserted into the framing structure 35 is evaluated by the current value M_{cur}. The operating state newABS predicted after a potential insertion of an additional ABS is evaluated by the predicted value Mₚᵣₑ. The final decision on whether to insert the ABS is taken if an overall improvement of a overall performance is expected to be achieved. As shown in the equation above, values PerfP1( ), PerfM1( ) of cell specific performance metrics determined based on cell specific radio resource models may be calculated. The values M_{cur}, Mₚᵣₑ of the overall performance metric M may be determined depending on the cell specific values PerfP1( ), PerfM1( ). In an embodiment the values PerfP1, PerfM1, M_{cur} and/or Mₚᵣₑ may be exchanged between the base stations 15, 21 as described above in connection with evaluating a possible handover.

The load balancing operation of inserting an ABS (step 63) may be automatically reverted. To this end, the macro base station 15 and/or the pico base station 21 may recalculate the overall performance metric in order to evaluate whether removing the ABS would increase the performance of the network 11. Again, the base stations 15, 21 may exchange the values PerfP1, PerfM1, M_{cur} and/or Mₚᵣₑ as described above in connection with evaluating a possible reverting of the ABS setting.

In an embodiment, the decision process of removing the ABS may be initiated by the macro base station 15 by requesting load information from at least one pico base station 21. Preferably, the macro base station 21 indicates to the pico base station 21 which ABS is intended to be declared to a normal (non-ABS) subframe. Furthermore, the macro base station 15 may request the cell specific performance metric or overall performance metric related to the current operating state and a predicted performance metric under the assumption that one ABS is removed from the framing structure 35.

Moreover, the macro base station 15 calculates the current and the predicted performance metrics related to the macro cell 13 and determines an overall performance, i.e., the values M_{cur} and Mₚᵣₑ. The values M_{cur} and Mₚᵣₑ may be determined as descried above, e.g., depending on cell specific values PerfM1, PerfP1. If comparing the values M_{cur} and Mₚᵣₑ shows that removing an ABS would improve the overall performance then the ABS is reverted to a normal subframe, otherwise not.

In an embodiment, handover decisions and decisions concerning adding or removing an ABS are taken independently from each other. In this embodiment, the macro base station 21 may have determined a fixed set of subframes during which the macro base station 21 uses a limited transmit power, e.g. by treating these subframes as ABS. Thus, a handover of a terminal 17 registered with the macro base station 15 in a cell border region (region A₂ except region A₁) is always possible since the terminal 17 can be reached by the pico base station 21 through a control channel in one of the subframes during which the transmit power of the macro base station 15 is limited (e.g. during the ABS). If the load in one of the pico cells 19 increases further then the pico base station 21 may request at least one further ABS from the macro base station 21 by sending a qualified muting request (see FIG. 5).

In another embodiment, no fixed set of subframes during which the transmit power of the macro base station 15 is limited, such as ABS, is configured. In this case, a handover request for a terminal 17 registered with the macro base station 15 and located in the cell border region of a pico cell 19 will fail because the pico base station 21 cannot communicate to this terminal 17 located too far away from the pico base station 21. In this embodiment, the handover rejection message send by the pico base station 21 back to the macro base 15 station may comprise the indication that the handover is rejected because of an insufficient control channel condition to the terminal due to a missing resource restriction by ABS in the macro cell 19. After having received this indication, the macro base station 15 may add at least one ABS into its framing structure 35 and request the handover again.

Regarding the performance criteria for the handover decision or the limiting of the transmit power, the minimum terminal bit rate of a cell may be used. For example, if the minimum of the two minimum bit rates of the pico cell 19 and the macro cell 13 is estimated to be increased if the handover is performed then the handover takes place, otherwise is does not take place.

In an embodiment, the evaluation 45 is performed by a single network element, e.g., the macro base station 15 or one of the pico base stations 21. At least one base station 15, 21 may signal a parameter characterizing a load value, preferably load in the extended coverage region (A₂ except region A₁), depending on a load of the cell 13, 19 controlled by this base station 15, 21 to said single network element. This parameter can be used to derive the current and predicted performance value preferably of the pico cell 19 assuming a potentially changed ABS setting by the macro base station 15. This parameter may be conveyed in a muting request. This allows that the receiving side can use its current and predicted performance metrics to put into the evaluation and take the decision based on this information. The load value may also correspond to a number nₚ of terminals 17 in the extended coverage region (A₂ except region A₁) or the number of terminals nₚ, nₘ registered with the cell 13, 19. In an embodiment, the parameter characterizing the load is quantized in relation to predefined load thresholds and can have one of a few discrete values only, such that the parameter can be represented by a set of 1 bit, 2 bits, 3 bits, 4 bits, or even more bits. This bitset can easily be integrated into the muting request.

In general, the radio resource management model (RRM model) estimates the performance of the network 11, a group of cells (e.g. a macro cell 13 and the pico cells 19 located at least partially within that macro cell 13), or a single cell 13, 19 by evaluating parameters that can be easily obtained, e.g., by measurement procedures or acquisition of an operating state of a network element such as the base stations 15, 21 or the terminal 17.

In the following, two exemplary RRM models are described. A first RRM model allows for calculating a performance metric for a handover decision where some subframes in the macro cell have a limited transmit power (e.g. ABS).

In a simplified approximation, performance metrics for handover decision for a Pico cell can be expressed by the following equation (with round robin assumption). The Pico cell throughput (under the assumption that an incoming or outgoing terminal is served in the subframes with limited transmit power) can be approximated as follows.

$$RRM\_pico ( xHO ) = \frac{( MSF / 10 ) * {N}_{RB}}{NPMUE + x} {\sum }_{b = 1}^{NPMUE + x} Th ( SIR ( {PMUE}_{b} ) ) + \frac{( NSF / 10 ) * {N}_{RB}}{NPNUE} {\sum }_{b = 1}^{NPNUE} Th ( SIR ( {PNUE}_{b} ) )$$

RRM_Pico(xHO) gives the throughput of the Pico cell. It is assumed that the available resources in the subframes with limited transmit power are equally distributed among the PMUEs which have to be served in the subframes with limited transmit power because they are located in the overlapping region (region A₂ except region A₁) and the available resources in the normal subframes are equally distributed among the PNUEs which can be served in the normal subframes because they are located in the center region of a Pico cell (region A₁ in FIG. 1).

Evaluation of performance metrics for handover decision for a macro cell can be expressed by the following equation.

$$RRM\_Macro ( xHO ) = \frac{( NSF / 10 ) * {N}_{RB}}{NMUE - x} {\sum }_{b = 1}^{NMUE - x} Th ( SIR ( {MUE}_{b} ) )$$

RRM_Macro(xHO) gives the throughput of the macro cell averaged over a radio frame. It is assumed that the available resources in the normal subframes are equally distributed among the MUEs because they can only be served in the normal subframes.

The meaning of the symbols used in the above equations is as follows.

$$xHO = \{ \begin{matrix}no HO ; & when no handover is assumed \\ with HO ; & when handover is assumed\end{matrix} \\ x = \{ \begin{matrix}0 ; & when no handover is assumed \\ 1 ; & when handover from macro to pico is assumed \\ - 1 ; & when handover from pico to macro is assumed\end{matrix}$$

N_{RB} number of available physical resource blocks (PRB) for a given frequency band
MSF number of muted (almost blank) subframes per radio frame (10 subframes)
NSF number of normal subframes per radio frame (10 subframes)
NPMUE number of Pico UEs served in muted subframes per radio frame
NPNUE number of Pico UEs served in normal subframes per radio frame
NMUE number of Macro UEs served in the Macro base station (served in normal subframes)
Th(SIR(PUE_{b})) throughput (in bits/s) from one PRB for UE_{b} (spectral efficiency of UE_{b})

The same method with these simplifications can be applied to obtain e.g. the minimum terminal bitrate in a cell and take this as RRM_pico(xHO).

In the following, an example for performance metrics for additional ABS setting is given when some subframes are muted in the Macro cell (i.e. some subframes are ABS). In a simplified approximation, performance metrics for additional ABS setting decision for a pico cell can be expressed by the following equation (with round robin assumption).

$$RRM\_pico ( xABS ) = \frac{[ ( MSF + m ) / 10 ] * {N}_{RB}}{NPMUE} {\sum }_{b = 1}^{NPMUE} Th ( SIR ( {PMUE}_{b} ) ) + \frac{[ ( NSF - m ) / 10 ] * {N}_{RB}}{NPNUE} {\sum }_{b = 1}^{NPNUE} Th ( SIR ( {PNUE}_{b} ) )$$

RRM_Pico(xABS) gives the throughput of the Pico cell. It has to be noted that the number NPMUE and NPNUE of UEs classified in muted or normal subframes can also depend on the muted subframe setting m.

Evaluation of performance metrics for additional ABS setting for a Macro cell can be simplified expressed by the following equation.

$$RRM\_Macro ( xABS ) = \frac{[ ( NSF - m ) / 10 ) * {N}_{RB}}{NMUE} {\sum }_{b = 1}^{NMUE} Th ( SIR ( {MUE}_{b} ) )$$

RRM_Macro(xABS) gives the throughput of the macro cell averaged over a radio frame.

The additional symbols used in these equations have the following meaning.

$$xABS = \{ \begin{matrix}currABS ; & when ABS settings not modified \\ newABS ; & when ABS settings modified\end{matrix} \\ m = \{ \begin{matrix}0 ; & when ABS settings not modified \\ 1 ; & when number of ABS increased by 1 \\ - 1 ; & when number of ABS decreased by 1\end{matrix}$$

The same approach with these simplifications can be applied to come e.g. to the minimum terminal bitrate in the cells and take this as performance indication to derive the ABS setting decision from.

To sum up, the embodiments of the present invention allow for improving the overall performance of a wireless network, in particular a set of radio cells comprising a macro cell 13 and at least one pico cell 19 overlapping at least partially with that macro cell 13. To this end embodiments of the present invention perform decisions on restricting resource usage by the macro base station 15, in particular limiting a transmit power of a portion of a radio transmission resources 32 including inserting ABS in the framing structure 35 of the macro cell 13. Furthermore, decisions on reverting these restrictions may be performed. Moreover, handover decisions concerning handovers of terminals 17 from the macro base station 15 to a pico base station 21 may be taken either if the control channel of the macro base station 15 cannot longer reach the terminal 17 or in order to off load traffic to the pico base station 21. In addition, decision related to handovers of terminal 17 from the pica base station 21 to the macro base station 13 may be performed. These decisions may be taken if the terminal 17 can no longer be reached by the control channel transmitted by the pico base station 21. A handover from a pico base station 21 to the macro base station 15 may also be determined to be necessary if the traffic in the pico cell 13 has increased and the traffic should be off loaded to the macro cell 13. By these decisions, the quality of service for the terminal 17, e.g. a minimum terminal bit rate in the system or the overall throughput of both the macro cell and the at least one pico cell 19, or another quality criteria, shall be improved.

The functions of the various elements shown in the Figures, including any functional blocks labeled as ‘processors’ or ‘control means 31’, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term ‘processor’ or ‘controller’ should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown. A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

1. Method for deciding on a potential load balancing operation in a wireless network comprising a first base station having a first cell and at least one second base station having a second cell, the first cell and the second cell at least partially overlapping each other, wherein the method comprises evaluating an impact of the potential load balancing operation to an overall performance metric, said metric characterizing the performance of the first cell and the at least one second cell, and performing the load balancing operation if said evaluating indicates that the potential load balancing operation would improve the performance according to the performance metric, wherein the method comprises transmitting a limiting request from the second base station to the first base station for requesting the first base station to limit the transmit power of the signal transmitted over a portion of radio resources.

2. Method of claim 1 wherein the network is a cellular network, the first cell being a macro cell and the second cell being a pico cell, a coverage area of the pico cell being smaller than a coverage area of the macro cell, and wherein the first base station is a macro base station controlling the macro cell and the second base station is a pico base station controlling the pico cell.

3. Method of claim 1, wherein said evaluating comprises calculating a current value of the performance metric related to a current operating state of the first cell and the at least one second cell and calculating a predicted value of the performance metric related to an operating state of the first cell and the at least one second cell that would appear if the load balancing operation would be performed.

4. Method according to claim 1 wherein the values of performance metric are determined based on a radio resource management model, the performance metric preferably comprising a minimum terminal bitrate.

5. Method according to claim 1, wherein the method comprises determining at least one cell specific value of a cell specific performance metric, said cell specific value characterizing the performance of the first cell or the second cell, and determining the current value and/or the predicted value depending on the current value and predicted values of the at least one cell specific performance metric.

6. Method according to claim 1, wherein the method comprises exchanging with network elements, preferably with the first base station and/or the second base station, the cell specific values as current and predicted values, and/or the values of the overall performance metric, and/or an indication on whether said evaluating indicates that the potential load balancing operation would improve the performance according to the performance metric.

7. Method according to claim 1, wherein performing the load balancing operation comprises triggering an handover of a terminal from the first cell to the second cell or from the second cell to the first cell.

8. Method according to claim 7, wherein the method comprises transmitting to a handover target base station at least one parameter characterizing radio conditions related to the terminal, preferably a pathloss between the terminal and at least one base station.

9. Method according to claim 7, wherein performing the load balancing operation comprises limiting a transmit power of a signal transmitted by the first base station over a portion of radio resources of the first cell and the second cell, said portion preferably corresponding to a time interval, preferably a frame or a subframe of a framing structure of the wireless network, or a portion of the frame or the subframe.

10. Method according to claim 9, wherein the method comprises reverting said limiting the transmit power and evaluating an impact of reverting limiting the transmit power to the overall performance metric and reverting said limiting if said evaluating indicates that said reverting would improve the performance according to the performance metric.

11. Method according to claim 9, wherein the method comprises determining at least one cell specific value of a cell specific performance metric, said cell specific value characterizing the performance of the first cell or the second cell, and wherein the predicted value of one cell is derived in approximation from a load information submitted in relation to predefined thresholds.

12. Method according to claim 11, wherein the load balancing operation comprises transmitting a handover request message from the first base station to the second base station and signalling to the second base station a portion of the radio resources on which the first base station is willing to limit the transmit power.

13. Method according to claim 11, wherein the load balancing operation comprises transmitting a handover request from the first base station to the second base station and receiving a handover rejection from the second base station, the handover rejection indicating whether the second base station cannot accept the requested handover due to insufficient control channel radio condition to the terminal.

14. Network element for a wireless network, said network comprising a first base station having a first cell and at least one second base station having a second cell, the first cell and the second cell at least partially overlapping each other, wherein the network element comprises control means arranged for evaluating an impact of a potential load balancing operation to an overall performance metric, said metric characterizing the performance of the first cell and the at least one second cell, and performing the load balancing operation if said evaluating indicates that the potential load balancing operation would improve the performance according to the performance metric, wherein the control means are arranged for transmitting a limiting request from the second base station to the first base station for requesting the first base station to limit the transmit power of the signal transmitted over a portion of radio resources.

15. Network element of claim 14, wherein the network element is the first base station or the at least one second base station, the control means of which being arranged for executing a method.
